(19) United States
(12) Patent Application Publication
(10) Pub. No.: US 2025/0338881 A1
(43) Pub. Date: Nov. 6, 2025

(54) SYSTEMS AND METHODS FOR CANNABINOID-INFUSED BEE PRODUCT

(71) Applicant: Aaron Blaine Appleby, Pullman, WA (US)

(72) Inventor: Aaron Blaine Appleby, Pullman, WA (US)

(21) Appl. No.: 18/653,745

(22) Filed: May 2, 2024

(51) Int. Cl. A23L 21/25; A01K 47/06; A01K 59/06; A23L 29/00

(52) U.S. Cl. CPC A23L 21/25; A01K 47/06; A01K 59/06; A23L 29/035

(57) ABSTRACT

A method is provided for producing a bee product infused with one or more target compounds. In one embodiment, the method includes constraining pollen collection by bees to a selection of plants and extracting a plant-derived material from bee hives. The method further includes measuring a content of the one or more target compounds of the cannabinoid-plant-derived material and packaging the plant-derived material based on the content of the one or more target compounds.

### FIELD

Embodiments of the subject matter disclosed herein relate to ambrosia (bee bread), processes for infusing ambrosia with cannabinoids, and food products enhanced with cannabinoid-infused ambrosia.

### BACKGROUND

Certain plant species are dioecious plants having male and female flowers on separate plants. The male flowers produce pollen that may be collected on bodies of pollinators on transported by pollinators, such as bees, to a base location of the pollinator, such as a hive. The pollen from the flowers may be converted into ambrosia or bee bread at the base location via chemical reactions that break down the pollen grains. The resulting ambrosia may be infused with target compounds and may have desirable medicinal and/or nutritional properties when consumed by other organisms.

### BRIEF DESCRIPTION OF THE DRAWINGS

Various techniques will be described with reference to the drawings, in which:

FIG. 1 is a perspective view of a system for controlling pollen collection by bees, according to an embodiment of the disclosure;

FIG. 2 is a perspective view of a first example of a structure for controlling pollen collection by bees, according to an embodiment of the disclosure;

FIG. 3 is a front view of the structure of FIG. 3, according to an embodiment of the disclosure;

FIG. 4 is a rear view of the structure of FIG. 3, according to an embodiment of the disclosure;

FIG. 5 is a perspective view of a second example of a structure for controlling pollen collection by bees, according to an embodiment of the disclosure;

FIG. 6 is a front view of the structure of FIG. 5, according to an embodiment of the disclosure;

FIG. 7 is a rear view of the structure of FIG. 5, according to an embodiment of the disclosure;

FIG. 8 is a diagram of an example of a geographic area selected for controlling pollen collection by bees, according to an embodiment of the disclosure;

FIG. 9 is an overview of a process for producing a cannabinoid-infused bee product, according to an embodiment of the disclosure;

FIG. 10 is an example of a method for producing a cannabinoid-infused bee product, according to an embodiment of the disclosure; and

FIG. 11 is an overview of pollen collection by bees, which may be leveraged to produce a cannabinoid-infused bee product, according to an embodiment of the disclosure.

### DETAILED DESCRIPTION

In the preceding and following description, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

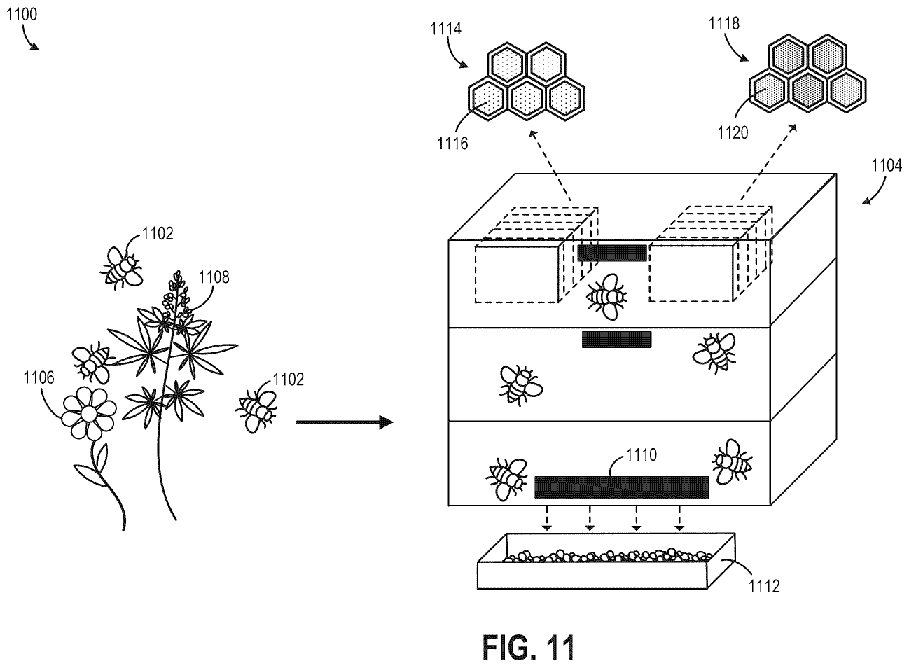

Bees frequent flowers to collect both nectar (a sugar-rich liquid containing carbohydrates and amino-acids) and pollen (a protein-rich powder composed of gametophytes and containing lipids, vitamins, flavonoids, and micronutrients), as described further below with reference to FIG. 11. While nectar can be directly consumed by the bees, pollen may not be readily digested in its pristine form, e.g., as collected directly from plants, due to a hard outer wall (exine) of the pollen grains. Instead, the bees may mix the pollen with saliva, stomach fluid, as well as nectar and honey, and store the pollen mixture at combs of a bee hive. Enzymes in the bees' saliva and stomach fluid, along with microorganisms present in the hive, may promote fermentation of the pollen grains, which may include at least partial decomposition of the exine. Fermentation of the pollen may convert the pollen into ambrosia or bee bread, which increases a bioavailability of nutritionally dense content of the pollen (e.g., proteins, lipids vitamins, flavonoids, micronutrients, etc.).

In at least one embodiment, the pollen-producing flowers may be male flowers of plants that produce one or more target compounds, such as male cannabis or cannabinoid-producing plants. In at least one other embodiment, the pollen-producing flowers may instead be male flowers of a dioecious plant, such as ginkgos, willows, asparagus, and holly, among others. The pollen of the male plants may include various compounds and chemical species that may be desired to incorporate into products such as food additives. For example, cannabis plants may produce one or more types cannabinoids, including, but not limited to cannabinol (CBN), tetrahydrocannabinol (THC), cannabigerol (CBG), and cannabidiol (CBD). The cannabinoids found in cannabis plant pollen, along with secondary metabolites, such as terpenoids, flavonoids, sterols, and other phytochemical compounds included in a composition of the pollen, may impart the pollen with desirable nutritional and medicinal properties. By ingesting bee bread produced from cannabis plant pollen, nutritional and medicinal effects of the cannabinoids may be obtained, Furthermore, at least some of the cannabinoid compounds in the pollen may have low heat tolerance and may be prone to degradation when exposed to temperatures above 104° C., for example. Ingestion of the bee bread without previously having subjected the bee bread to elevated temperatures may be desirable to maximize the nutritional and medicinal benefits of the cannabinoids.

To maximize the nutritional and medicinal effects of consuming cannabis plant-derived bee bread, it may be desirable to obtain a monofloral bee bread converted from cannabis plant pollen. The monofloral bee bread may be bee bread having a composition, such as 75% or greater by pollen count, predominantly derived from pollen obtained from one cannabinoid-producing plant species, in contrast to multifloral bee bread, which may be composed of numerous different types of pollen without any one pollen type forming greater than 50% by pollen count of the bee bread composition. In at least one embodiment, the monofloral bee bread may have a composition of 85% of its pollen count that is derived from one cannabis plants species. In at least one embodiment, the monofloral bee bread may be composed of phytochemicals from a single floral source. In order to increase the cannabis pollen count of bee bread, techniques for controlling bee pollen collection, as described herein, may be implemented. In at least one embodiment, bee pollen collection control processes may include one or more processes of employing a physical structure to define boundaries of bee travel or cultivating a region of land for agriculture to promote pollen collection from cannabis plants.

In at least one embodiment, a method for obtaining a bee product infused with one or more target compounds, such as constraining pollen collection by a plurality to bees to a selection of plants, such as cannabis plants, and extracting a plant-derived material, such as nectar, pollen, and/or bee bread, that includes the one or more target compounds from one or more hives of the plurality of bees. In at least one other embodiment, a method comprises moderating collection of pollen and/or nectar by a plurality of bees to a selected group of plants or selected type of plants. The method may further include leveraging accumulation and storage of the pollen and/or nectar at the one or more hives to extract a desired material from the pollen and/or nectar. A content of the target one or more compounds in the bee product may further be determined. For example, for cannabinoid-producing plants, the method may also include measuring a cannabinoid content of the cannabis plant-derived material. The cannabis plant-derived material may be packaged as the cannabinoid-infused bee product based, at least in part, on the cannabinoid content. As described herein, a cannabinoid-infused bee product may be a product obtained directly or indirectly from bee activity that is charged, enhanced or supplemented with one or more cannabinoid compounds either through a naturally occurring process (e.g., in a bee hive) or through a controlled process that replicates a naturally occurring process.

In at least one other embodiment, a system for obtaining a bee product infused with one or more target compounds, comprises one or more hives housing pollen-collecting bees and a plurality of selected plants surrounding the one or more hives. In at least another embodiment, a system may be provided for obtaining a bee product produced by bees from pollen and/or nectar collected from pollen and/or nectar-producing plants. The system may further include a constraint imposed on how the bees collect a bee product. For example, for pollen collection, a constraint on the pollen-collecting bees to cause the pollen-collecting bees to obtain pollen from the plurality of cannabis plants, the pollen to be used to produce a bee product infused with the one or more target compounds.

In at least one other embodiment, a bee product collected by the bees may include a desired material at a content at least reaching a desired threshold. For example, a cannabinoid-infused bee product may comprise a cannabinoid content derived from cannabis plant pollen. The pollen content from cannabinoid-producing plants may form 90% or greater of a pollen count of the cannabinoid-infused bee product, as an example. In yet another example, the pollen content from cannabinoid-producing plants may form at least 75% of a pollen count of the cannabinoid-infused bee product. In at least one embodiment, a desired material collected by the bees may be present in a resulting bee product at a content of greater than 50%.

In at least one embodiment, a bee product obtained via process described herein may be used in various applications as a result of constraints imposed on collection of one or more materials forming the bee product. For example, honey and/or pollen may be obtained with a desired floral content (e.g, monofloral or multifloral), or a desired content of target materials present in honey and/or pollen due to a plant source of the honey and/or pollen. As another example, cannabis plant-derived pollen obtained via one or more of the processes for controlling bee pollen collection described herein may be further provided as a food additive via a process for producing a cannabinoid-infused bee product. For instance, the bee product may be a mixture of honey, such as monofloral or multifloral honey, and cannabinoid-producing plant-derived pollen. In another example, the bee product may be a mixture of honey and cannabinoid-infused bee bread. In yet another example, the bee product may additionally or alternatively include one or more of propolis, royal jelly, beeswax, etc. By combining the cannabis plant-derived pollen or bee bread with honey, the nutritional and medicinal benefits thereof may be enhanced by nutritional properties of the honey. Moreover, mixing the pollen or bee bread with honey may provide a more palatable and versatile food additive that may readily added to a variety of food types.

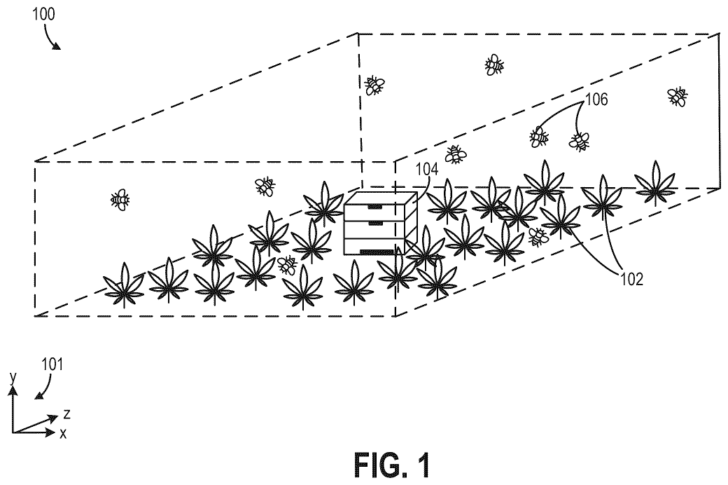

In at least one embodiment, a system and process for controlling collection of plant-based materials by bees, such as bee pollination, may include constraining bee travel by using a system, as shown in FIG. 1, that promotes collection of pollen from cannabis plant species. Although the following discussion is focused on collection of pollen, and, specifically, from cannabis plant species, the methods and systems described below may be similarly used to obtain various other plant-based materials via organisms known to collect such materials. For example, collection of pollen by other pollen-collecting insects or collection of nectar by other nectar-collecting insects may also be controlled in a similar manner.

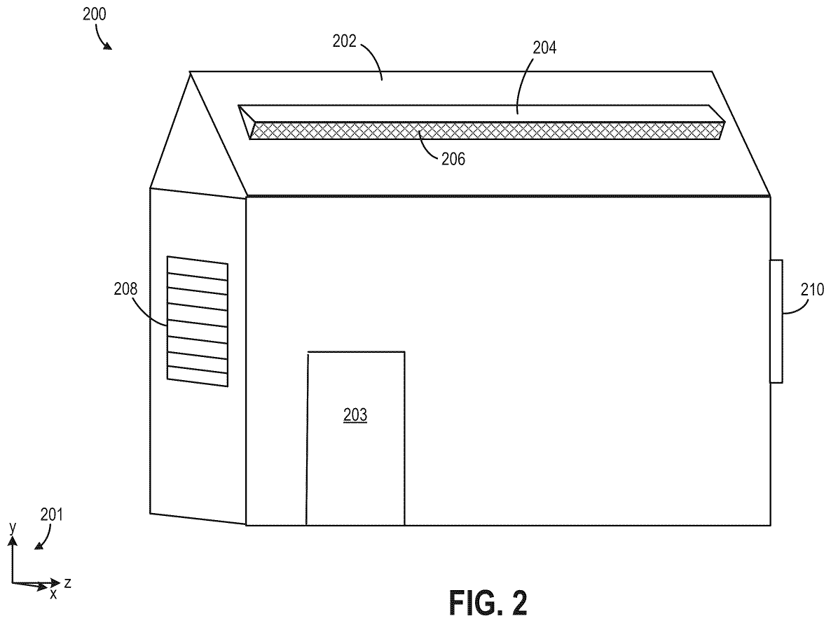

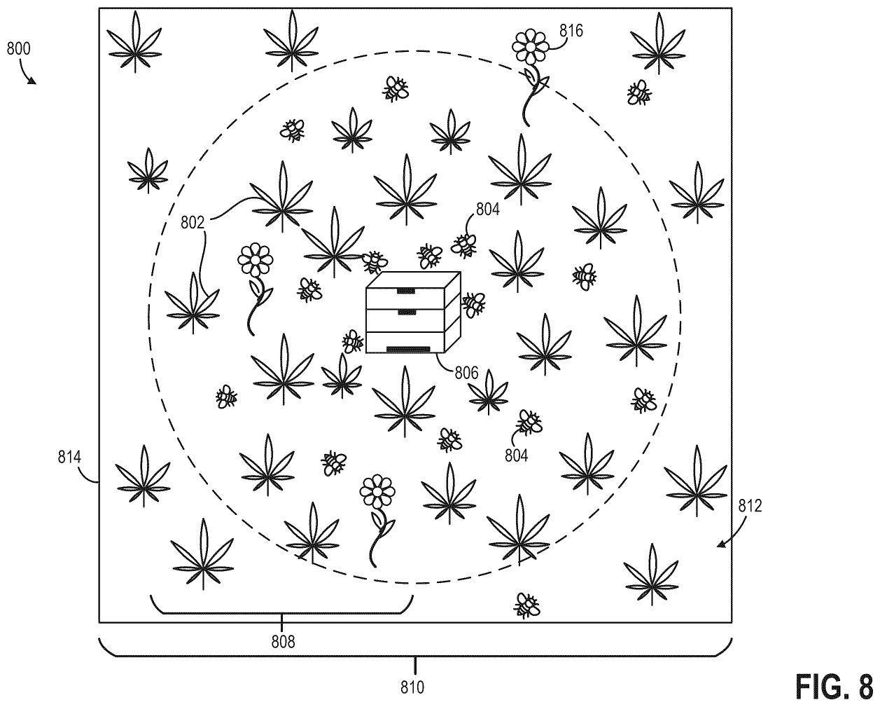

As one example, moderation of bee travel may be achieved by constructing a structure to enclose one or more cannabis plant species, as shown in FIGS. 2-7. For example, the structure may be a greenhouse or a hoop house that surrounds a beehive and confines the bees therein, where the one or more cannabis plant species may provide an exclusive source of pollen to the bees. In at least one other embodiment, bee pollination may instead be controlled by constraining availability of pollen sources within a distance travelled by the bees. In other embodiments, interaction of organisms with plants may be selectively controlled using any one of the structures shown in FIGS. 2-7. For example, one or more bee hives may be located in a region that is selectively cultivated to promote collection of cannabinoid-infused pollen by bees, as shown in FIG. 8. In at least one embodiment, the region may be greater than a distance travelled by the bees, over a duration of activity of the bees, thereby causing the bees to obtain pollen only from sources within the region. In at least one other embodiment, the region may be equal to or less than the distance travelled by the bees but the bees may be motivated to remain within the region due to the selective cultivation of the region with at least pollen-producing plants.

In at least one embodiment, by controlling collection of pollen by bees, e.g., which plants the pollen is obtained from, a cannabinoid-infused bee product may be obtained using the pollen. In at least one embodiment, the cannabinoid-infused bee product may be a monofloral bee product, where the pollen is collected from a single cannabis plant species. Alternatively, in at least one other embodiment, the cannabinoid-infused bee product may be a multifloral bee product, where the pollen is collected from more than one cannabis plant species. In at least one other embodiment, a cannabinoid content of the cannabinoid-infused bee product may be determined and controlled as a result of controlling the pollen collected by the bees.

The cannabinoid-infused bee product may be, for example, cannabinoid-infused pollen, cannabinoid-infused bee bread, or a mixture of two or more of cannabinoid-infused pollen, cannabinoid-infused bee bread, and honey. In at least one embodiment, the cannabinoid-infused bee bread may be produced in one or more hives by natural fermentation of the cannabinoid-infused pollen in bee bread combs. In at least one other embodiment, the cannabinoid-infused bee bread may instead be produced via a process that replicates natural fermentation of the cannabinoid-infused pollen but may be performed outside of the one or more bee hives under controlled environmental conditions.

Turning now to FIG. 1, an example of a system 100 for controlling pollen collection is illustrated. A set of reference axes 101 are provided in FIG. 1, indicating a y-axis, an x-axis, and a z-axis. The y-axis, for example, may be parallel with a direction of gravity. In at least one embodiment, one or more hives 104 may be included in the system 100. The system 100 may include a plurality of plants 102, one or more hives 104, and bees 106. The one or more hives 104 may be a base location that houses one or more colonies of the bees 106 and provides an enclosure for storing food collected by the bees 106. In at least one embodiment, the one or more hives 104 may store combs produced by the bees 106 to accumulate and/or facilitate chemical conversion of food collected by the bees 106. For example, the collected food may be nectar and pollen transported to the one or more hives 104 to feed and sustain the one or more colonies, as described further below with reference to FIG. 11. Furthermore, different hives supporting different bee colonies may be rotated in and out of the system 100 to ensure the colonies have access to different nutrient sources, as described further below. By positioning the one or more hives 104 in the system 100, the bees may transport pollen from the plurality of plants 102 to the one or more hives 104. At the one or more hives 104, the pollen, as well as bee bread produced from the pollen, may be readily collected. Details of pollen collection, bee bread production, and bee bread collection from hives are provided further below with respect to FIG. 11.

In at least one embodiment, the system 100 may be a physical structure, as shown in FIGS. 2-7, and may include one or more transparent or translucent panels or sides that allows sunlight to penetrate therethrough. For instance, sunlight may pass through the one or more transparent or translucent panels to promote photosynthetic processes at the plurality of plants 102 and heat generated by photosynthesis may be captured by the structure to create an artificial environment therein that is different from an environment external to the structure. The structure may further include various devices and mechanisms for providing control of its inner environment, such as temperature control, humidity control, etc.

In at least one embodiment, the system 100 may include a geographic area, such as a field, as shown in FIG. 8, which may be planted with the plurality of plants 102. In at least one embodiment, the geographic area may be selected based on environmental conditions thereof that are suitable for the plurality of plants 102, such as climate, elevation, hours of daylight, a proximity to a urban area, etc. The plurality of plants 102 may be cultivated in the geographic area to utilize sunlight and receive nutrients, such as water, fertilizer, etc., to promote pollen production. In at least one embodiment, the system 100 may include a region that is already planted with the plurality of plants 102, such as a crop field.

In at least one embodiment, the plurality of plants 102 may include one or more plant species cultivated to produce a material that may be collected by other organisms. In at least one embodiment, the plurality of plants 102 may produce one or more or nectar or pollen and the organisms may be insects, such as bees. In at least one embodiment, the plurality of plants 102 may include cannabis plant species. At least a portion of the one or more cannabis plant species may be composed of male plants that produce pollen. For example, 50% or greater of a number of the one or more cannabis plant species included in the system 100 may be male plants. In at least one embodiment, the male cannabis plants may be the only male plants, e.g., an only source of pollen included in the system 100. In at least one embodiment, the one or more cannabis plant species may include Cannabis sativa (C. sativa). Further, in at least one embodiment, the system 100 may include only C. sativa plants, thereby causing pollen collected by the bees to be monofloral pollen composed primarily of C. sativa-derived cannabinoids. In other examples, however, the system 100 may include another cannabis plant species exclusively, or may include combinations of different cannabis plant species. Moreover, in at least some embodiments, the system 100 may also include additional plants that produce nectar to provide nutrients for the bees in addition to nutrients found in the pollen of the one or more cannabis plant species.

By selecting the species composition of the plurality of plants 102 and providing the selected species as a sole source of pollen to the bees 106, the pollen and bee bread collected at the hives 104 may be infused with target compounds and chemical species produced by the plant species. In at least one embodiment, as described above, when the plurality of plants 102 are exclusively male C. sativa plants, the pollen transported by the bees 106 and collected at the hives 104 may be monofloral pollen derived from C. sativa and infused with cannabinoids. Furthermore, in at least one embodiment, when the plurality of plants include only pollen-producing cannabis plants, 85% or greater of a total pollen count at the hives 104 may be cannabinoid-infused pollen. In examples, where more than one cannabinoid plants species may be present in the system 100, the pollen and bee bread may be multifloral cannabinoid-infused pollen and bee bread. In yet other examples, a portion of the plurality of plants 1012 may be composed of nectar-producing plants to provide the bees 106 with additional sources of nutrients. In such instances, the bees 106 may also produce honey at the hives 104, which may also be infused with cannabinoids due to mixing of pollen with the nectar at the hives 104.

By confining the bees 106 to forage within the system 100 and additionally placing the hives 104 in the system 100, the bees 106 may collect pollen from sources that are selectively cultivated in the system 100 to cause the bees 106 to produce pollen and bee bread with a desired infusion of cannabinoids. The infusion may be readily controlled by varying the variety or species and corresponding proportion (e.g., number of plants of a total number of plants included in the system 100). In order to maintain the bees 106 within the system 100, which, in at least one embodiment, may have an overall area that is smaller than a range that the bees 106 are likely to travel during hours of daylight in a day, the system 100 may be configured to effectively compel the bees 106 to remain in the system 100. In at least one embodiment, the system 100 may utilize a physical enclosure to confine the bees 106 therein. A first example of a structure for controlling pollen collection of bees is depicted in FIGS. 2-4.

An exemplary structure 200 is shown in FIGS. 2-4 from a perspective view, a front view, and a rear view, respectively. In at least one embodiment the structure 200 may be a permanent construction built to withstand ambient environmental conditions for a prolonged period of time and not configured to be moved (e.g., not portable). A set of reference axes 201 are provided for comparison between the views shown, indicating a y-axis, an x-axis, and a z-axis. In at least one embodiment, the y-axis may be parallel with a direction of gravity. The structure 200 may be an embodiment of the system 100 of FIG. 1 and may be, for example, a greenhouse enclosing a plurality of plants, one or more hives, and bees, such as the plurality of plants 102, the hives 104, and the bees 106 of FIG. 1. Further, the structure 200 may include one or more panels along one or more sides or a roof of the structure 200 that may be formed of a transparent or translucent material to allow sunlight to pass therethrough.

The structure 200 may include a door 203 for access to an interior of the structure 200 disposed in at least one side of the structure 200. An upper portion, e.g., relative to the y-axis, of the structure 200 may include upper panels 202, which may form a roof of the structure 200. The upper panels 202 may include one or more roof vents 204, extending along a length of the structure 200 (e.g., along the z-axis). The upper panels 202 may have various numbers of roof vents. For example, each of the upper panels 202 may have one roof vent 204, two roof vents 204, one of the upper panels 202 may have one or more roof vents 204 and the other of the upper panels 202 may have no roof vents 204, etc. Furthermore, although the structure 200 is depicted having two upper panels 202 in FIGS. 2-4, in other embodiments, the structure 200 may include other quantities of upper panels, such as four or six, etc. The roof vents 204 may allow exchange of gases between inside of the structure 200 and outside of the structure 200.

As shown in FIG. 2, the roof vents 204 may include openings that may be fitted with netting 206 that may cover the openings entirely. The netting 206 may be a mesh having a hole size (e.g., size of openings of the mesh) selected to block passage of objects and organisms therethrough. In at least one embodiment, the mesh size of the netting 206 may be sufficiently small to block small insects that may cause degradation to the plants enclosed within the structure. For example, the hole size may be 0.3×0.7 mm. In other embodiments, however, the mesh may be selected to specifically impede escape of bees from the structure 200 rather than to inhibit entry of other, smaller organisms. As an example, a mesh having a larger hole size of up to 3 mm×3 mm may be used, which may affect air flow through the mesh to a lesser extent than netting of smaller mesh sizes (e.g., smaller holes) and may also be less costly than smaller mesh sizes.

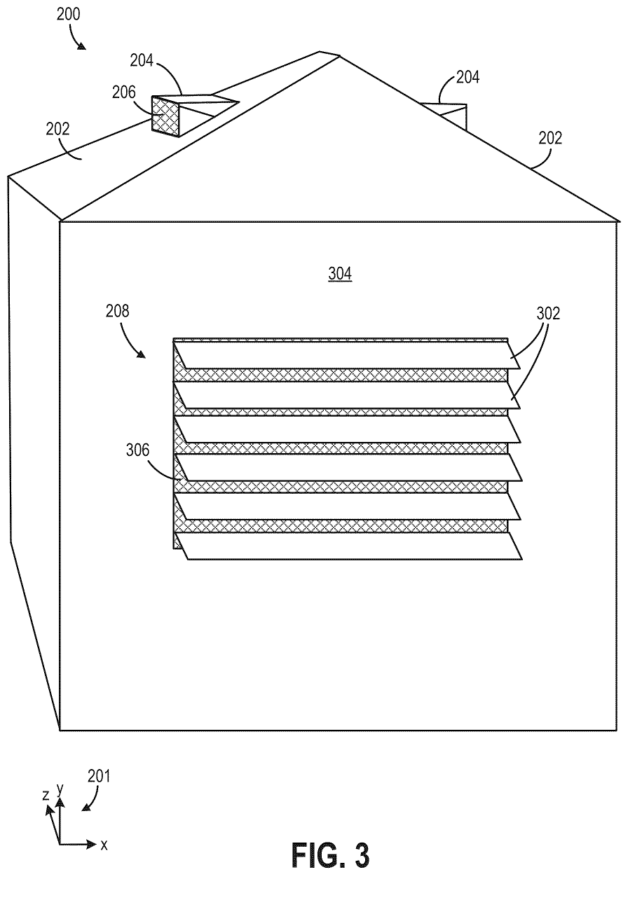

The structure 200 may also have climate control mechanisms and devices, including a cooling system 208 and an exhaust system 210, which may be placed on opposite sides of the structure 200. Other configurations are possible, however, such as positioning of the cooling system 208 and the exhaust system on adjacent sides of the structure 200. The cooling system 208 is shown in greater detail in FIG. 3, from the front view of the structure 200.

The cooling system 208 may be coupled to a first side surface or first wall 304 of the structure 200 and may be used to cool intake air entering the structure 200 when air external to the structure 200 is higher in temperature than a desired or target inner temperature of the structure 200. In at least one embodiment, the cooling system 208 may include heat exchange mechanisms such as louvers 302 and cooling pads (not shown in FIGS. 2-4) positioned behind the louvers 302 (e.g., positioned closer to an interior of the structure 200 than the louvers 302) to facilitate evaporative cooling of air passing through the cooling system 208. The louvers 302 may be pivotable flaps that may be adjusted to guide air flow into the cooling system 208, through the cooling pads. The cooling pads may, in at least one embodiment, be wetted with water for evaporative cooling. The cooling system 208 may, in at least one embodiment, use a coolant, such as polyalphaolefin (PAO), which may absorb heat from the air flow as air is pumped over the coolant to drive cool air throughout the structure 200. By varying an angle of the louvers 302 relative to the first wall 304 of the structure 200, e.g., relative to the y-axis, an amount of air flowing through the cooling system 208 may be increased or decreased according to a desired decrease in temperature inside the structure 200.

The cooling system 208 may form an opening in the first wall 304 of the structure 200. To block escape of bees through the opening, the cooling system 208 may be fitted with netting 306, which may be similar to the netting 206 of the roof vents 204. In at least one embodiment, the netting 306 may be positioned as a sheet of mesh arranged behind the louvers 302 and in front of the cooling pads. For example, the netting 306 may extend across the opening of the cooling system 208 in between the louvers 302 and the cooling pads such that the netting 206 is closer to the interior of the structure 200 than the louvers 302 but the cooling pads are positioned closed to the interior of the structure 200 than the netting 306. The positioning of the netting 306 relative to the louvers 302 and the cooling pads may vary, however, in other examples, without altering a use of the netting 306 to maintain the bees within the structure 200. For example, in at least some other embodiments, the netting 306 may alternatively be positioned across the opening of the cooling system 208 inside of the cooling pads or outside of the louvers 302, or multiple layers of the netting 306 may be included at the cooling system 208 at various positions relative to the louvers 302 and the cooling pads. Furthermore, other types of heat exchange mechanisms may be used in place of evaporative cooling, such as air-to-liquid cooling, refrigerant-based cooling, etc.

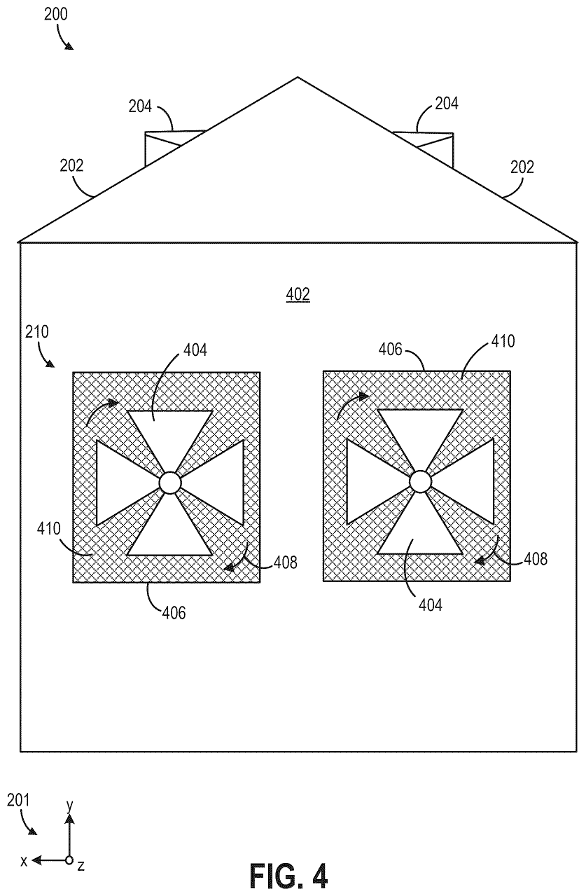

As shown in the rear view of FIG. 4, the structure 200 may also include the exhaust system 210 coupled to a second side surface or second wall 402 of the structure 200. The exhaust system 210 may include exhaust fans 404 positioned in openings 406 of the second wall 402. The exhaust fans 404 may rotate when activated, as indicated by arrows 408, to compel air flow out of the structure 200, which, in turn, may draw air into the structure 200 through the cooling system 208.

The openings 406 of the second wall 402 may be covered with netting 410 that is similar to the netting 206 of the roof vents 204, as described above. For example, the netting 410 may extend entirely across the opening 406, and may be positioned behind the exhaust fans 404, as shown in FIG. 4, such that the netting 410 may be closer to the interior of the structure 200 than the exhaust fans 404. Alternatively, the netting 410 may be positioned outside of the exhaust fans 404. In addition, while two of the openings 406 and two of the exhaust fans 404 are depicted in FIG. 4, other embodiments may include other quantities of the openings 406 and the exhaust fans 404. Moreover, each of the cooling system 208 and the exhaust system 210 may be placed in more than one wall of the structure 200, in other examples. Furthermore, an overall geometry of the structure 200 and relative sizes, placements, and shapes of components of the structure 200 may vary from those shown in FIGS. 2-4 without departing from the present disclosure.

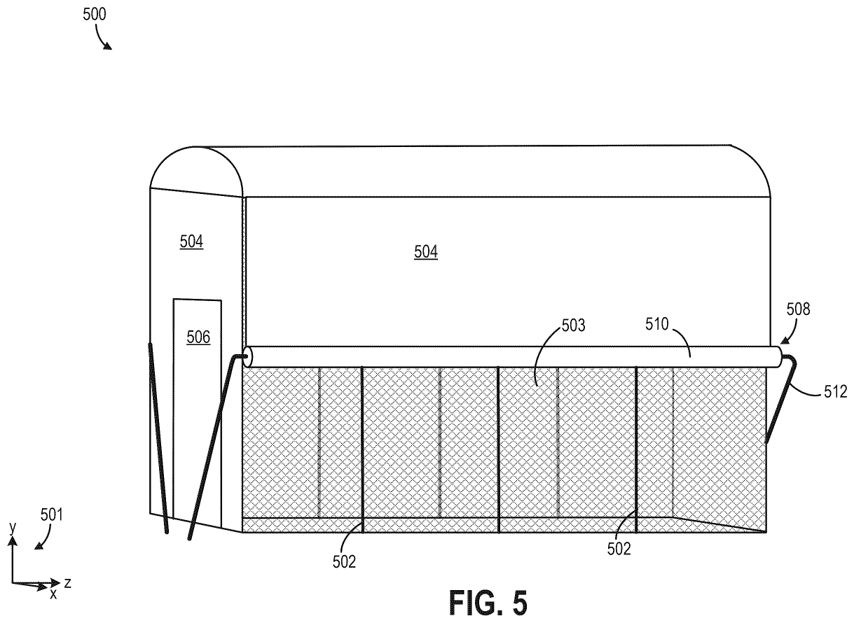

As shown in FIGS. 2-4, netting may be used to efficiently and effectively maintain bees within a permanent (e.g., not readily disassembled and removed) structure enclosing a selection of plants that causes the bees to obtain pollen from only the selection of plants. In at least one other embodiment, the structure may instead be a portable structure that is easily removable and having a less robust construction relative to a permanent greenhouse, for example. A second example of a structure relying on netting to maintain bees enclosed therein to control pollen collection by the bees is illustrated in FIGS. 5-7.

An exemplary structure 500 is shown from a perspective view, a front view, and a rear view in FIGS. 5-7, respectively. A set of reference axes 501 are provided for comparison between view shown, indicating a y-axis, an x-axis, and a z-axis. In at least one embodiment, the y-axis may be parallel with a direction of gravity. The structure 500 may be an embodiment of the system 100 of FIG. 1 that is used to control collection of plant-based materials by organisms, and, in contrast to the structure 200 of FIGS. 2-4, may be constructed to be temporary or portable. For example, the structure 200 may be a hoop house assembled to surround and enclose a plurality of plants, one or more hives, and bee, such as the plurality of plants 102, the hives 104, and the bees 106 of FIG. 1. As such, the structure 500 may lack the cooling system 208 and the exhaust system 210 of the structure 200 of FIGS. 2-4 for regulating a temperature within the structure 500.

As shown in FIG. 5, the structure 500 may be constructed similar to a tent, having rigid frame elements 502, such as hoops, covered by a transparent or translucent film 504, which may be stretched over the rigid frame elements 502. At least a portion of the structure 500, such as along one or more walls of the structure 500, a netting 503 may also be placed over the rigid frame elements 502, between the rigid frame elements 502 and the film 504. At least one side or wall of the structure 500 may include a door 506 to provide access to an interior of the structure 500. Because the structure 500 does not include devices for climate control therein, coverage provided by the film 504 may be adjustable to vary an amount of air exchange between an exterior of the structure 500 and the interior of the structure 500.

For example, the structure 500 may include one or more roller mechanisms 508 for varying a coverage of the film 504 across one or more vertical sides (e.g., aligned with the y-z plane) of the structure. The roller mechanisms 508 may include a roller 510 and a pivotable roller frame 512 that supports the roller 510. In at least one embodiment, the roller 510 may be wound with at least a portion of the film 504 along a wall of the structure 500. As an example, when the roller frame 512 is pivoted such that the roller 510 is aligned with a bottom of the structure 500, the roller 510 may be unwound and the film 504 may extend from a top (e.g., relative to the y-axis) of the corresponding wall of the structure 500 to a bottom of the wall. When the roller frame 512 is pivoted so that the roller 510 is raised above the bottom of the wall, the roller 510 may be wound with the film 504 so that less of the wall of the structure 500 is covered by the film 504. By varying an angle of the roller frame 512 an amount of coverage provided by the film 504 may be adjusted. For example, the roller 510 may be raised and winding of the film around the roller 510 increased to augment air exchange through the wall of the structure 500. Conversely, the roller 510 may be lowered and the film 504 unwound from the roller 510 to decrease air exchange through the wall.

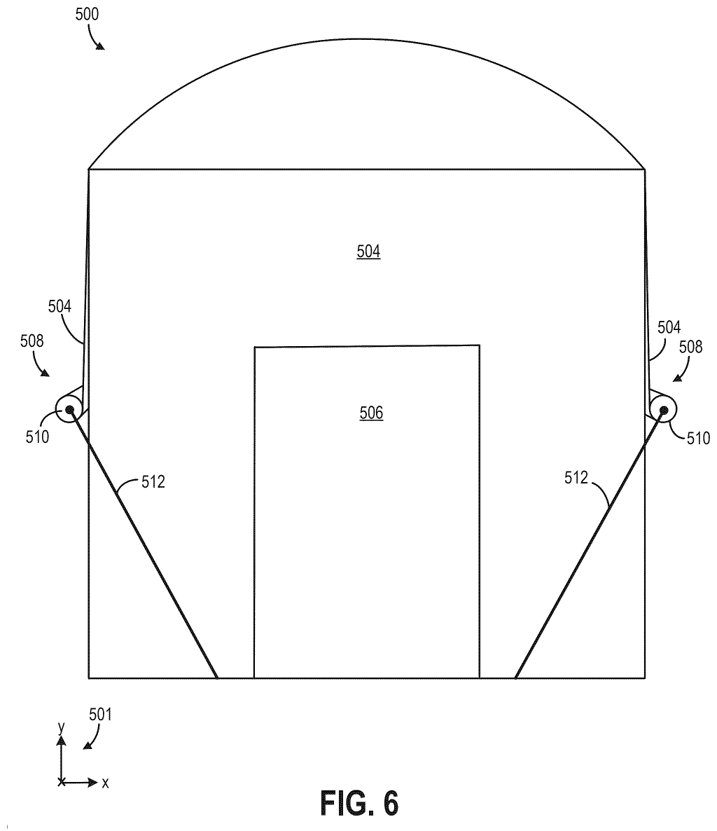

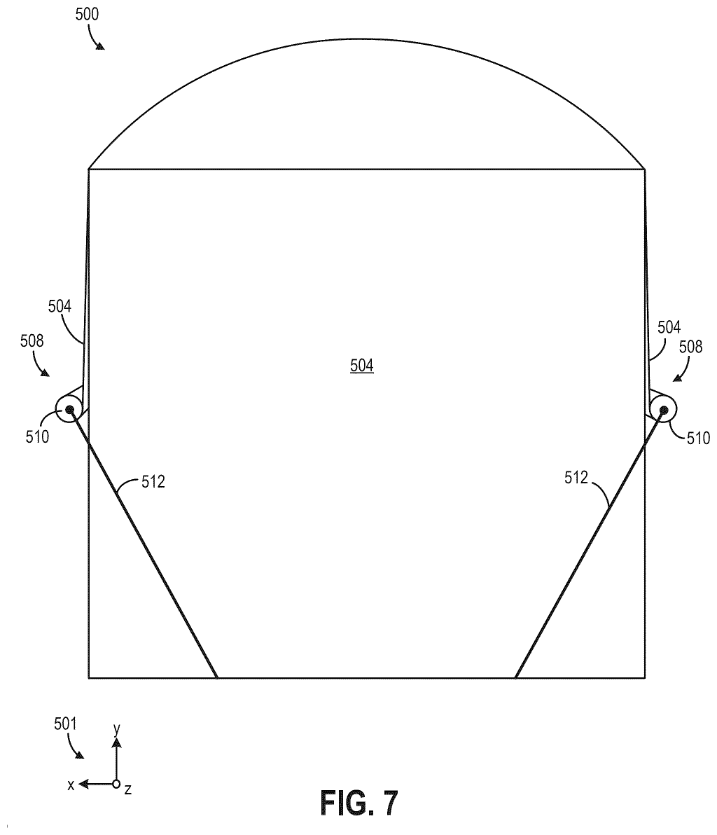

In at least one embodiment, when the temperature within the structure 500 increased above a threshold temperature that is higher than a target temperature or temperature range within the structure 500, and/or higher than an ambient temperature outside of the structure 500, the temperature within the structure 500 may be decreased by adjusting the roller mechanisms 508 to allow air inside the structure 500 to exchange with air outside the structure 500. In particular, by positioning the roller mechanisms 508 at opposite walls, as shown in FIGS. 6 and 7, air flow through the structure 500 may be effectively moderated. In at least one embodiment when the ambient temperature outside of the structure 500 is lower than a target temperature or temperature range for inside of the structure 500, the roller mechanisms may be adjusted to increase coverage of one or more walls of the structure 500 with the film 504 to increase insulation of air inside the structure 500 by maintaining heat generated via photosynthesis facilitated by plants enclosed within the structure 500.

The netting 503 of the structure 500, as illustrated in FIG. 5, may be similar to the netting 206, 306, and 410 of FIGS. 2-4, respectively. For example, as described above, the netting 503 may be of a mesh size that impedes escape of the bees from the structure 500, without adversely affecting airflow therethrough. In at least one embodiment, the netting 503 may be secured, attached, or otherwise coupled to the rigid frame elements 502 such that the netting 503 remains unchanged and covering the corresponding side of the structure 500 when the roller mechanisms 508 are adjusted. In other embodiments, the netting 503 may be a continuous material that is coupled to the rigid frame elements 502 by stretching the netting 503 over the rigid frame elements 502 rather than directly securing or attaching the netting 503 to the rigid frame elements 502. In at least one embodiment, the netting 503 may entirely cover at least sides of the structure 500 where coverage provided the by film 504 is adjustable.

Although the structure 500 is depicted with two roller mechanisms 508 arranged on opposite sides, the structure 500 is a non-limiting example of a temporary construction that may be used to cause bees to collect pollen from a selection of plants to produce bee bread having a desired composition of chemical species derived from the selection of plants. For example, an overall geometry, number of rigid frame supports, number of walls, number of roller mechanisms to adjust film coverage, a configuration of the roller mechanisms, may vary from those shown in FIGS. 5-7 without departing from the scope of the present disclosure.

As an alternative to physically constraining bee travel to food sources, e.g., by placing the bees and associated hives within a structure such as a greenhouse or hoop house, a source of pollen available to the bees may instead be constrained without affecting a natural distance travelled by the bees. In at least one embodiment, instead of enclosing and imposing constraints on bee travel, bee pollination may instead by moderated by selectively providing pollen sources to the bees according to a maximum distance covered by bee travel over a threshold duration of time. Further, in at least one embodiment, travel of a variety of organisms known to collect materials from plants may be constrained to collecting the materials from selected plants by positioning a base location of the organisms in an area cultivated with only the selected plants, where a size of the area correspond to travel of the organisms over a threshold duration of time.

For example, the threshold duration of time may be between a period of time between sunrise and sunset that an ambient temperature is warm enough to promote activity of the bees. Over the threshold duration of time, when the bees are honey bees, the honey bees bees may travel as far as 8.5 miles from a base location of the bees. This may represent a maximum distance that the honey bees may travel under extreme conditions with poor availability of resources. Alternatively, when the base location is positioned within a location rich in resources, the maximum distance the honey bees may travel may be reduced to 0.7 miles. The maximum distance of bee travel may vary depending on a genus and species of the bees. For example, when the bees are instead bumble bees, the bumble bees may travel a maximum distance of 2.5 miles over the threshold duration time when availability of resources is low. By positioning the base location of the bees, such as one or more hives, within a predetermined geographic area with a radius equal to or greater than a distance the bees are known to travel, food collection by the bees may be constrained to be within the predetermined geographic area. In at least one embodiment, a minimum size of the predetermined geographic area may be a diameter of 8.5 miles.

In at least one embodiment, as shown in FIG. 8, the predetermined geographic area may be a field 800 that is selectively planted with a plurality of pollen-producing plants 802. one or more cannabis plant species. The field 800 may be an embodiment of the system 100 of FIG. 1. For example, at least a portion of the plurality of pollen-producing plants 802 may be one or more cannabis plant species. In at least one embodiment, the plurality of pollen-producing plants 802 may be entirely composed of male C. sativa plants. In at least one embodiment, 50% or greater of a plant count of the plurality of pollen-producing plants 802 of the field 800 may be the one or more cannabis plant species and in at least one other embodiment, 50% or greater of a number of plants of the one or more cannabis plants species may be male cannabis plants. In at least one embodiment, the plurality of pollen-producing plants 802 may be entirely composed of male C. sativa plants. In addition, in at least some embodiments, the plurality of pollen-producing plants 802 may be the only source of pollen within the field 800.

In at least one embodiment, the field 800 may have an area that is greater than a distance that the bees 804 may travel within a day. For example, during hours where an ambient temperature is warm enough to promote bee activity, the bees 804 may travel over a maximum distance and return to one or more hives 806 before an ambient temperature falls below a threshold temperature, such 10° C. In at least one embodiment, the one or more hives 806 may be positioned in a center of the field 800. A radius of travel 808, as indicated by a dashed circle, of the at least 90% of the bees 804 of a colony may be, for example, 3.5 miles away from the one or more hives 806. A total distance 810 across the field 800 may be greater than 7 miles in diameter. Furthermore, the radius of travel 808 of at least 75% of the bees 804 may be, for example, 1.5 miles away from the one or more hives 806. As such, in at least one embodiment, the total distance 810 across the field 800 may be greater than 3 miles in diameter. For example, the total distance 810 (e.g., diameter) across the field 800 may be 8 miles, 9 miles, or 10 miles, although other distances, both smaller and larger, are possible. As 10% or less of the bees 804 of the colony may travel further than a radius of 3.5 miles from the one or more hives 806, a majority of the bees 804 may collect pollen exclusively from within the radius of travel 808. The pollen-producing plants 802 may also be planted in a region 812 outside of an outermost boundary of the radius of travel 808 inside of an edge 814 of the field 800. For example, by planting male C. sativa plants outside of the radius of travel 808 of the bees 804, a likelihood may be increased that bees travelling beyond the radius of travel 808 also collect pollen from the male C. sativa plants.

In at least one embodiment, the total distance 810 across the field 800 may not be greater than an area bounded by the radius of travel 808. For example, the total distance 810 may be 7 miles or less than 7 miles. Although the bees 804 may be able to travel further beyond the edge 814 of the field 800, the bee 804 may be motivated to remain within the field by increasing an availability of pollen proximate to the hives 806. As an example, a density of the pollen and nectar-producing plants 802 may be greatest adjacent to the hives 806 and may decrease with distance away from the hives 806 and increasing proximity to the edge 814 of the field. Moreover, the field 800 may be cultivated such that pollen and nectar-producing plants are sparse beyond the edge 814 of the field 800 and within the maximum distance the bees 804 are able to travel (e.g., up to a diameter of 8.5 miles for honey bees and 2.5 miles for bumble bees), thereby decreasing a likelihood that the bees travel beyond the edge 814 of the field 800 to seek food. As a result, monofloral pollen may be collected and monofloral bee bread may be produced by the bees 804. Alternatively, multifloral pollen and multifloral bee bread may be produced by the bees 804 when the plurality of plants include more than one cannabis plant species.

In at least one embodiment, the bees 804 may be further compelled to remain within the radius of travel 808 by providing the bees 804 with additional sources of sustenance. In at least one embodiment, nectar may be provided to the bees 804 within the field 800. For example, nectar-producing plants 816 may be planted within the radius of travel 808. In at least one embodiment, the nectar-producing plants 816 may include exclusively plant species that only produce nectar and not pollen. By providing sources of nectar within the field 800, any nutritional elements not provided by the pollen that would otherwise cause the bees 804 to seek additional food sources (e.g., sources of nectar) may be supplemented by the nectar-producing plants 816.

As described above, hives positioned within a structure, as shown in FIGS. 2-7, or placed in a field cultivated with selected plant species, as shown in FIG. 8, may be rotated into the structure or field to collect pollen therefrom and rotated out of the structure or field after a predetermined duration of time. When the hives are rotated out of the structure or field, pollen and/or bee bread may be collected from the hives. The pollen and/or bee bread may be used as additives to food items, e.g., food additives, to enhance the food items with nutrients included in the pollen and bee bread. In at least one embodiment, the food additive may be a bee product that includes one or more materials produced by bees. As an example, the food additive may be a mixture of bee bread and honey. The bee bread and the honey may both be obtained from the hives, for example, or a precursor to the bee bread, e.g., pollen, and the honey may both be obtained from the hives. In yet another example, the precursor to the bee bread may be obtained directly from pollen sources, such as pollen-producing plants, and added to honey obtained from the hives.

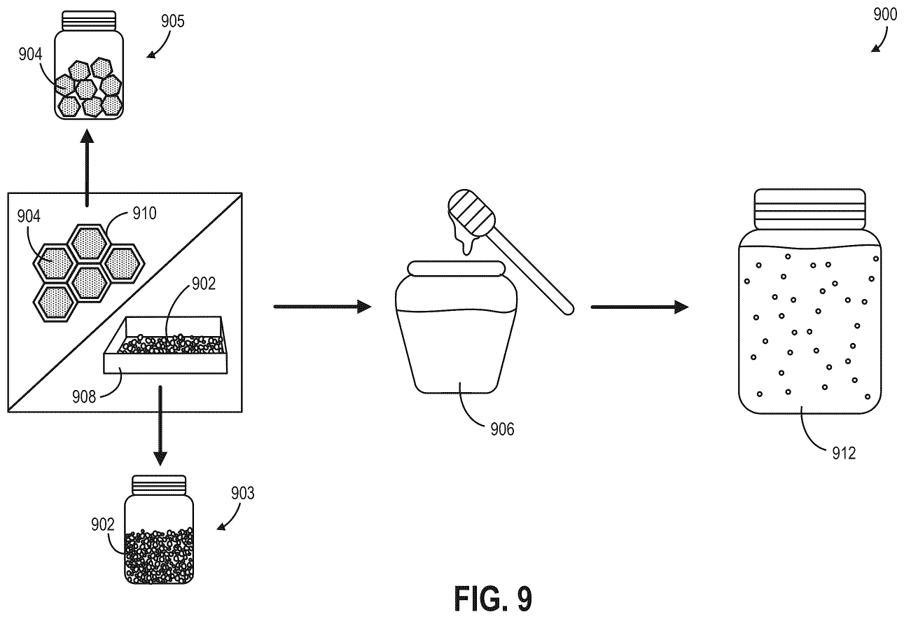

A process 900 for forming a food additive composed of bee products is depicted in FIG. 9. The process 900 may include obtaining plant-based materials, such as pollen 902 and/or bee bread 904 to be added to honey 906. The plant-based materials incorporated into one or more food additives shown in the process 900 are non-limiting examples of products that can be derived from materials collected by organisms, e.g., bees, from plants. Other products, and processes for handling, packaging, and otherwise preparing plants materials collected by organisms are possible. In at least one embodiment, the pollen 902, the bee bread 904, and the honey 906 may be obtained from the same hive. In other embodiments, however, the pollen 902, the bee bread 904, and the honey 906 may be obtained from different hives. Additionally, in at least one embodiment, at least the pollen and the bee bread 904 may be obtained from one or more hives that were placed in a structure, such as the structures 200 of FIGS. 2-4, and 500 of FIGS. 5-7, or in a selectively cultivated field, such as the field 800 of FIG. 8, to infuse the pollen 902 and the bee bread 904 with cannabinoids. In at least one embodiment, the pollen 902 and the bee bread 904 may be monofloral bee products, having pollen counts that include 75% or greater of pollen derived from one cannabinoid-producing plant species. In at least one other embodiment, however, the pollen 902 and the bee bread 904 may be multifloral bee products having pollen counts that include pollen derived from more than one cannabinoid-producing plant species, with each type of pollen forming no greater than 50% of a pollen count of the multifloral bee products.

In at least one embodiment, the pollen 902 may be collected in a pollen-collection device, similar to element 1112 shown in FIG. 11 and described further below. For example, the pollen-collection device may be a tray 908 coupled to the hives proximate to an entrance to the hives. As the bees enter the hives, pollen may be knocked off the bees by combs or other exclusionary devices and fall off the bees into the tray, which may be arranged such that the bees cannot access the pollen collected in the tray. In at least one alternate embodiment, the pollen may instead be collected without relying on the bees. For example, the pollen may be directly extracted from the cannabinoid-producing plant species manually or by an automated (e.g., machine-based) process. In at least one embodiment, direct extraction of pollen from the cannabinoid-producing plant species may include shaking the pollen off the cannabinoid-producing plant species into collection vessels.

In at least one embodiment, the pollen 902 may be collected and packaged without further processing to be provided as a first bee product 903 which may be used as a food additive. In at least one embodiment, the pollen 902 may be collected and crushed to reduce a grain size of the pollen 902, prior to packaging thereof. By crushing the pollen 902, an integrity and continuity of an exine of the pollen grains may be degraded to allow interior materials of the pollen grains to be exposed. In at least one embodiment, the pollen 902 may be packaged in containers and sealed. By controlling the variety and/or species of the plants from which the pollen 902 was collected from, e.g., either by controlling bee travel or by direct pollen extraction from the plants, a cannabinoid content of the pollen 902, e.g., a weight percentage of cannabinoids per pollen grain, may be maximized.

In at least one embodiment, the cannabinoid content of the pollen 902 may be determined using one or more analytical techniques including, but not limited to chromatography (e.g., gas chromatography, high performance liquid chromatography (HPLC)), mass spectrometry, ultraviolet absorbance. The one or more analytical techniques may also be used to identify the cannabinoid species present in the pollen 902. Serving size recommendations for the first bee product 903 may thereby be provided based on the determined cannabinoid content of the pollen 902. Furthermore, the pollen 902 may be provided as a monofloral or multifloral bee product, depending on the pollen sources from the pollen 902 was obtained.

In at least one embodiment, the bee bread 904 may be obtained from the hive by extracting the bee bread 904 from bee bread combs 910 produced by the bees in the hive. For example, the bee bread combs 910 may be located in a different region in the hive from where honeycombs, also produced by the bees, may be located, allowing the bee bread combs 910 to be readily distinguished from the honeycombs and removed from the hive for bee bread extraction. The bee bread 904 may be separated from the bee bread combs 910 by a variety of techniques, including, but not limited to, soaking the bee bread combs 910 in water, utilizing vibration and/or drying, vacuum drying, and/or mechanically crushing the bee bread combs 910 and optionally filtering out the combs, which may be formed of wax, from the bee bread 904.

In at least one embodiment, the bee bread 904 may be extracted and packaged without further processing to be provided as a second bee product 905 which may be used as a food additive. In at least one embodiment, the bee bread 904 may be collected and crushed to reduce a grain size of the bee bread 904, prior to packaging thereof. For example, the bee bread 904 may be packaged in containers and sealed. By controlling the variety and/or species of the plants from which the bee bread 904 was collected from, e.g., either by controlling bee travel, a cannabinoid content of the bee bread 904, e.g., a weight percentage of cannabinoids per pollen grain, may be determined. Serving size recommendations for the second bee product 905 may thereby be provided based on the determined cannabinoid content of the bee bread 904. Furthermore, the bee bread 904 may be provided as a monofloral or multifloral bee product, depending on the pollen sources from the which bee bread 904 was produced.

The collected pollen 902 and/or the extracted bee bread 904 may be added to the honey 906 in a desired ratio to form a third bee product 912, which may be used as a food additive. In at least one embodiment, the pollen 902 and/or the bee bread 904 may be added to the honey 906 without further processing. In at least one other embodiment, the pollen 902 and/or the bee bread 904 may be crushed before being added to the honey 906. By crushing the pollen 902 and/or the bee bread 904, the pollen 902 and/or the bee bread 904 may be more evenly distributed within the honey 906. Furthermore, for the pollen 902, crushing the pollen 902 may expedite a duration of time required for the pollen 902 to be converted to bee bread in the honey 906, as described further below.

The third bee product 912 may be a mixture of the honey 906 with the pollen 902 and/or the bee bread 904. The honey 906 may be monofloral or multifloral and may be formed from nectar collected from a variety of nectar-producing plants species by the bees. The nectar may be undergo several chemical changes, which may include fermentation at the hives in honeycombs to produce the honey 906. By determining a cannabinoid content of the pollen 902 and/or the bee bread 904, and adding a known quantity of the pollen 902 and/or the bee bread 904 to a known quantity of the honey 906, a cannabinoid content of the third bee product 912 may be known and controlled.

In at least one embodiment, the third bee product 912 may be a mixture of the pollen 902 obtained from pollen-producing plants and the honey 906. In at least one embodiment, the third bee product 912 may be a mixture of the bee bread 904, converted from pollen at one or more hives and extracted from the bee bread comb 910 of the hives, and the honey 906. In at least one embodiment, the third bee product 912 may instead be a product that is fermented subsequent to mixing of the pollen 902 with the honey 906, which may result in conversion of the pollen 902 to bee bread.

The conversion of the pollen 902 to bee bread when selectively mixed with the honey 906 may be a fermentation process that replicates conversion of pollen to bee bread in a hive (e.g., replicate fermentation). For example, as described further below with reference to FIG. 11, fermentation of pollen may be facilitated by enzymes and microbes present in bee saliva and naturally-occurring microbes present in a hive. To promote replicate fermentation, mixing the pollen 902 with the honey 906 may expose the pollen 902 to enzymes (from bee saliva) and microbes in the honey 906, which may be present in the honey 906 due to conversion of nectar into the honey in a hive. Under controlled environmental conditions, the pollen 902 may be converted to bee bread in the honey 906. In at least one embodiment, the controlled environmental conditions may include maintaining a temperature of the pollen/honey mixture in a temperature range of 30° C. to 40° C., without direct exposure to sunlight, maintaining a humidity within a range of 55-60% to resemble a humidity within a hive, etc. In at least one embodiment, the mixture may be maintained at 34° C., under 55-60% relative humidity, to stimulate storage in a hive, which may yield a pH of 4.2-4.5 of resulting pollen and bee bread samples.

While fermentation of pollen to form bee bread may require at least a duration of two weeks in a hive, replicate fermentation may be accelerated by mechanically decomposing an exine of the pollen grains. Chemical decomposition of the exine may be slow but crushing the pollen 902 to allow interior components of the pollen grains to be immediately exposed to enzymes and microbes present in the honey 906 upon addition of the pollen 902 to the honey 906 may expedite the fermentation. In at least one embodiment, conversion of the pollen 902 to bee bread in the honey 906 may be reduced by a period of 3 to 5 days. In at least one embodiment, replicate fermentation may be further accelerated by adding sources of the enzymes found in bee saliva and/or adding additional colonies of the microbes that are present in hives.

In at least one embodiment, to replicate fermentation of pollen into bee bread, a lactic acid fermentation caused by bacteria and yeasts may be induced to either pollen collected from cannabinoid-producing plant species, or from pollen traps attached to hives of bees foraging in cannabinoid-producing plants. In at least one embodiment, the plurality of plants may include one or more cannabis plant species. In at least one other embodiment, the plurality of plants may include one or more male, pollen-producing cannabis plants species. In at least another embodiment, the plurality of plants may include only male C. sativa plants. One hundred and thirteen or more yeasts are associated with pollen from flowers and bee bread, the yeasts belonging to 12 genera of which the genera Torulopsis, Candida, and Cryptococcus comprise 85% of the organisms. For example, Torulopsis magnoliae (T. magnoliae) is the most common species representing 43% of the yeasts. T. magnoliae is part of the bee gut microbial community and is not found on pollen from plants. Instead, T. magnoliae is found on pollen from pollen sacks found in traps or in bee bread. T. magnoliae and other organisms (yeasts, bacteria, and other fungi such as Saccharona spp.) may be added to pollen collected from cannabinoid-producing plants at specific times to aid in fermentation of bee bread, either through direct fermentation or used as sources of proteins, lipids, and growth factors for the microbes actively involved in fermentation.

In at least one embodiment, there may be four phases of microbial development in fermenting pollen that occur within seven days from collection in the hive. This fermentation begins with the presence of lactic acid bacteria, yeasts, indole-producing bacteria (Escherichia), and sporulating aerobic bacteria. During a first phase of fermentation, the development of a diverse group of microorganisms, including yeasts, may occur and last up to 12 hours. In a second phase of fermentation, anaerobic lactic acid bacteria (Streptococcus) utilize growth factors produced by the yeasts and putrefactive bacteria, which may lower the pH of the pollen. A third phase of fermentation includes disappearance of Streptococcus while Lactobacillus populations increase. Lactobacillus produce more acid than Streptococcus, which may further reduce the pH of the pollen. During a fourth phase, which begins at the end of the seventh day, a reduction of lactic acid bacteria and certain yeasts may occur due to the large quantity of lactic acid produced, resulting in a pH of approximately 4-5. As such, if these organisms are not present in the pollen, the organisms may be added to the pollen and honey mixture at different times to begin the fermentation and progress the process through each stage.

By using the pollen 902, where a cannabinoid content of the pollen 902 may be determined, a cannabinoid content of a resulting bee bread formed from the pollen 902 via replicate fermentation may also be known. The known cannabinoid content of the bee bread may be used to select an amount of bee bread to be mixed with a selected quantity of the honey 906 to achieve a desired cannabinoid content of the third bee product 912.

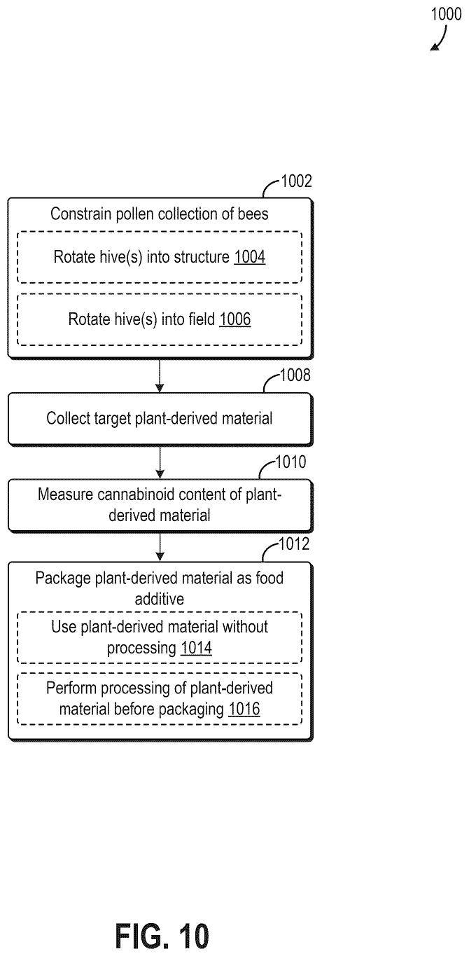

A method 1000 for obtaining a bee product infused with cannabinoids is shown in FIG. 10. Method 1000 is a non-limiting example of a series of operations or actions which may be performed to obtain a plant-based product derived from materials collected by organisms. In at least one embodiment, at least portions of method 1000 may be performed manually by a technician, or as an automated process, e.g., by machines or specialized equipment, or as a combination thereof. Method 1000 may utilize bees of one or more bee colonies, each of the bee colonies supported by one or more hives as a base location. The one or more hives may be rotated in and out of various locations described below to maintain the plurality of bee colonies healthy, e.g., by providing the one or more bee colonies with varied food sources.

At 1002, method 1000 may include constraining pollen collection of the bees. In at least one embodiment, constraining pollen collection may include placing the one or more hives in a selected location, which may include one or more locations indicated by dashed boxes in FIG. 10. In at least one embodiment placing the one or more hives in the selected location may include, at 1004, rotating the one or more hives into a structure used to enclose a plurality of plants. In at least one embodiment, the plurality of plants may include one or more cannabis plant species. In at least one other embodiment, the plurality of plants may include one or more male, pollen-producing cannabis plant species. In at least another embodiment, the plurality of plants may include only male C. sativa plants.

In at least one embodiment, the system may be any of the structure 200 of FIG. 2-4, or the structure 500 of FIGS. 5-7. By placing the one or more hives, and the associated colonies of bees, in the structure, the bees may be confined to forage for food only within the structure. Pollen transported to the one or more hives by the bees may be derived only from the plurality of plants enclosed in the structure, which may allow a cannabinoid composition of the pollen to reflect the plants species present in the structure. In at least one embodiment, the structure may include netting to maintain the bees within the structure and blocking various openings of the structure. For example, the netting may be positioned at intake openings, such as a cooling system, or outflow areas, such as an exhaust system, or at least portions of the structure, such as walls of the structure, may be formed of the netting.

In at least one embodiment, constraining pollen collection by placing the one or more hives in the selected location may include, at 1006, rotating the one or more hives into a field, such as the field 800 of FIG. 8, that may be selectively cultivated with a plurality of plants. In at least one embodiment, the plurality of plants may include one or more cannabinoid-producing plant species. In at least one other embodiment, the plurality of plants may include one or more male, pollen-producing cannabis plants species. In at least another embodiment, the plurality of plants may include only male C. sativa plants.

In at least one embodiment, the one or more hives may be placed in a middle region of the field. In at least one embodiment, a radius of the field, e.g., a distance from the one or more hives to an edge of the field may be greater than a distance traveled by the bees within a daily duration of activity of the bees. In at least one other embodiment, the radius of the field may be equal to or less than the distance traveled by the bees within the daily duration of activity of the bees. In such instances, an availability of food (e.g., pollen from the plurality of plants) within close proximity to the one or more hives may motivate the bees to remain within the field while foraging for food.

In at least one embodiment, constraints on pollen collection may be imposed on the bees by one or more of rotating the one or more hives into the structure at 1004 and rotating the hives into the field at 1006. As an example, the one or more hives may be rotated between being located within the structure and being placed in the field. In another example, the one or more hives may be positioned both within the structure and within the field. For example, the structure may be placed in the field to enclose the one or more hives, and the bees, therein. In at least one embodiment, the structure may be a hoop house that may be relocated between the field and another geographic location, or to different portions of the field supporting different cultivated plant species.

At 1008, method 1000 may include collecting target (e.g., desired) plant-derived materials. In at least one embodiment, the target materials may be collected from the one or more hives when the hives are rotated out of the selected location. For example, the one or more hives may be removed from the selected location to be transported to another location. Upon retrieval of the one or more hives from the selected location, the plant-derived materials may be extracted from the one or more hives. Alternatively or additionally, collecting the target materials may include collecting the plant-derived materials directly from the plurality of plants.

In at least one embodiment, the plant-derived materials may be pollen. As one example, the pollen may be collected from pollen collection devices, such as pollen traps or trays, coupled to the one or more hives. In at least one embodiment, the pollen may be collected from the plurality of plants rather than from the one or more hives. For example, the pollen may be shaken off of the plurality of plants into collection vessels. When obtained directly from the plurality of plants, the pollen may be collected independent of a placement of one or more hives and during a period of time or over a season that the plurality of plants produce pollen.

In at least one embodiment, the plant-derived materials may be bee bread. The bee bread may be formed in bee bread combs in the one or more hives. Upon retrieval of the one or more hives from the selected location, the bee bread combs may be removed from the one or more hives and treated to extract the bee bread from the bee bread combs, as described previously.

At 1010, method 1000 may include measuring a cannabinoid content of the plant-derived material. In at least one embodiment, measuring the cannabinoid content may include obtaining one or more representative samples from the plant-derived material and performing an analysis on the one or more representative samples. For example, techniques including gas chromatography, high performance liquid chromatography (HPLC), mass spectrometry, and ultraviolet absorbance may be used to quantify an amount of cannabinoids in the representative samples, identify which cannabinoid species are present in the representative samples, and to determine relative ratios of the cannabinoid species. Analytical results obtained through analysis of the one or more representative samples may be extrapolated to represent the cannabinoid content and composition of the plant-derived material.

At 1012, method 1000 may include packaging the plant-derived material as a food additive. In at least one embodiment, the plant-derived material may be a bee product. Packaging the plant-derived material may include more than one process as indicated by dashed boxes. In at least one embodiment, at 1014, the plant-derived material may be packaged for distribution as a food additive without processing of the plant-derived material. As an example, the plant-derived material may be pollen, collected either from the one or more hives or directly from the plurality of plants, and may be packaged without performing any additional procedures to modify the pollen prior to packaging. As another example, the plant-derived material may be bee bread, extracted from the bee bread combs collected from the one or more hives. The bee bread may also be packaged without performing any additional procedures to modify the bee bread prior to packaging.

In at least one embodiment, packaging the plant-derived material without performing any processing may include storing a predetermined amount of the plant-derived material (without any additional materials) in a vessel according to the determined cannabinoid content of the plant-derived material. In at least one embodiment, the vessel storing the plant-derived material may include an indication, such as a label, of the cannabinoid content of the plant-derived material stored therein.

In at least one embodiment, packaging the plant-derived material without processing may include adding the plant-derived material to another plant-derived material and packaging the plant-derived materials as a mixture. In at least one embodiment, the mixture may be a mixture of pollen and bee bread. In at least one other embodiment, the mixture may be a mixture of pollen and honey. In yet another embodiment, the mixture may be a mixture of bee bread and honey. Further, in at least one embodiment, the mixture may be a mixture of pollen, bee bread, and honey.

Regardless of the constituents of the mixture, a cannabinoid content of the mixture may be determined and indicated.

In at least one embodiment, at 1016, the plant-derived material may be processed prior to packaging of the plant-derived material to be used as a food additive. For example, procedures may be performed to modify the plant-derived material. In at least one embodiment, the plant-derived material may be pollen and the pollen may be processed by crushing (e.g., mechanically) the pollen to reduce a grain size and increase a bioavailability thereof. The crushed pollen may be packaged (without any additional materials) to be used as a food additive or may be added to honey to be packaged as a mixture of pollen and honey to be used as a food additive.

In at least one embodiment, the plant-derived material may be bee bread and the bee bread may be further processed by crushing (e.g., mechanically) the bee bread to reduce a grain size of the bee bread such that an amount of the bee bread add to food may be easily controlled. The crushed bee bread may be packaged to be used as a food additive or may be added to honey to be packaged as a mixture of bee bread and honey for use as a food additive. As another example, the crushed bee bread may be mixed with pollen or crushed pollen, in addition to honey, to form a mixture to be used as a food additive.

In at least one embodiment, the plant-derived material may be pollen, and the pollen may optionally be processed by crushing the pollen into smaller-sized grains. In at least one embodiment, the crushed or non-crushed pollen may be added to honey and allowed to ferment for at least a threshold period of time to be converted to bee bread. In at least one embodiment, the threshold period of time may be three days, although other time frames are possible. During the threshold period of time, a mixture formed of the crushed pollen and the honey may be maintained at target environmental conditions, such as within a controlled temperature range and humidity range. In at least one embodiment, the plant derived material (e.g., a mixture of the crushed pollen and the honey) may be further processed by adding materials that may accelerate fermentation. For example, enzymes and microbial cultures may be added. A resulting fermentation product may be packaged and used as a food additive.

In at least one embodiment, whether the plant-derived material undergoes processing or not, a cannabinoid content of a final food additive formed of the plant-derived material may be determined. The cannabinoid content may indicated to a consumer, e.g., by labelling the packaged plant-derived material and the determined cannabinoid content may further be used to provide a recommended serving size.

An overview of a process 1100 for production of a target plant-based product collected from plants by organisms is depicted in FIG. 11. As shown in FIG. 11, the plant-based product may be bee bread formed in a hive from pollen deposited therein. The process 1100 may be performed at least in part by bees 1102. In at least one embodiment, the bees 1102 may rely on plant-derived materials, such as nectar and pollen, for food and may forage for the food to transport the food to a hive 1104 that houses the bees 1102. For example, the hive 1104, may be a man-made structure, as shown in FIG. 11, or may instead be a structure formed by the bees 1102.

The hive 1104 may be a base location for the bees 1102 that provides shelter for the bees 1102 and a structure in which food for the bees 1102 may be stored and converted to more bioavailable forms. In at least one embodiment, the conversion of food for the bees 1102 includes chemical conversion and/or fermentation of nectar to form honey and fermentation of pollen to form bee bread. The nectar is a sugar-rich liquid composed of carbohydrates and amino acids and the pollen is a protein-rich powder composed of lipids, vitamins, flavonoids, and micronutrients, the micronutrients including gametophytes. Together, the nectar and the pollen may fulfill nutritional needs of the bees 1102, although in order to obtain nutritional value from the pollen, fermentation of the pollen is demanded to render nutrients provided by the pollen to be bioavailable to organisms.

The bees 1102 may travel up to a certain distance from the hive 1104 to collect nectar and pollen (such as up to a distance of 8.5 miles for honey bees and up to 2.5 miles for bumble bees) from the hive 1104 within a daily period of activity (e.g., during a period within a day that ambient temperature is sufficiently warm to promote bee activity). However, approximately 75% of the bees 1102 belonging to a colony inhabiting the hive 1104 may remain within 1.5 miles of the hive 1104. By selecting and providing the sources of pollen available to the bees 1102, a composition of the collected pollen may be controlled, as described above with reference to FIGS. 1-10. In at least one embodiment, the sources of pollen may be selected to include exclusively cannabis plants to promote collection of cannabinoid-infused pollen by the bees 1102.

In at least one embodiment, the cannabinoid plants be composed of C.sativa plants, such as pollen-producing male C. sativa plants. C.sativa plants are wind pollinated and do not produce nectar. The male C. sativa may produce large quantities of protein-rich pollen that may provide a nutritionally-dense food source for the bees 1102, particularly late in a growing season of nectar-producing plants when the bees 1102 may collect food in preparation for winter. Various types of cannabinoids may be found in pollen collected from C. sativa plants, including but not limited to Δ9-tetrahydrocannabinol (THC), cannabichromene (CBC), cannabicitran (CBT/CBTC), cannabinol (CBN), cannabigerol (CBG), cannabidiol (CBD), cannabicyclol (CBL), Δ9-tetrahydrocannabivarin (THCV), cannabidivarin (CBDV), dihydrocannabinol, cannabielsoin, 9,10-epoxycannabitriol, Δ9-tetrahydrocannabiorcol, 10-Oethylcannabitriol, 6a,7,10a-trihydroxytetrahydrocannabinol, and 7,8-dehydro-10-O-ethylcannabitriol.

The bees 1102 may collect nectar from nectar-producing plants 1106 and transport the nectar in their honey sacs, or honey stomachs, to the hive 1104. The bees 1102 may also gather pollen from pollen-producing plants 1108 and transport the pollen to the hive 1104 via pollen baskets on their legs. At the hive 1104, as the bees 1102 enter the hive 1104 through an opening 1110 of the hive 1104, a portion of the pollen carried by each of the bees 1102 may fall off the bees 1102 to be collected by a pollen collection device 1112, which, in at least one embodiment, may be a pollen trap or tray 1112.

In at least one embodiment, the pollen trap or tray 1112 may be coupled to the hive 1104 proximate to the opening 1110. For example, the pollen trap or tray 1112 may be removably coupled to a bottom of the hive 1104, below the opening 1110, and may be covered by a screen with pores large enough to allow pollen to pass through but not the bees 1102. The screen may thereby block the bee 1102 from accessing the pollen stored in the pollen trap or tray 1112. By decoupling the pollen trap or tray 1112 from the hive 1104, the pollen collected therein may be retrieved.

In at least one embodiment, the nectar collected by the bees 1102 may be packed into cells of a plurality of honeycombs 1114, along with bee saliva and bee stomach fluid. Enzymes in the saliva and stomach fluid may promote ripening and changes to the chemical composition of the nectar into honey 1116. In at least one embodiment, the pollen collected by the bees 1102 may be packed into cells of a plurality of bee bread combs 1118. For example, the pollen may be mixed with bee saliva, bee stomach fluid, nectar, and honey and packed into the cells of the plurality of bee bread combs 1118 to ferment the pollen. Fermentation of the pollen may be promoted by a humidity and temperature within the hive 1104, which may cause microorganisms (e.g., bacteria, yeasts, and other fungi) in the plurality of bee bread combs 1118 and guts of the bees 1102, along with the enzymes in the saliva and stomach fluid to decompose the pollen grains into bee bread 1120. The pollen may thereby be chemically converted to bee bread in a presence of acids produced by the microorganisms and materials present in the bee bread combs 1118. In at least one embodiment, conversion of the pollen into the bee bread 1120 may occur over a duration of two weeks.

While pollen may be a source of vitamins and minerals beneficial for health, a bioavailability of nutrients in the pollen to an organism consuming the pollen may be constrained due to the pollen's exine (a hard outer wall of the pollen grains). For example, the pollen may include minerals such as potassium, phosphorous, calcium, magnesium, and iron, as well as proteins, lipids, and antioxidants. The exine, however, may not be readily decomposed by an organism's digestive tract, which may inhibit release of nutrients included in an inner portion of the pollen grains. In contrast, when the pollen is fermented to become bee bread, the exine may be broken down, which may increase the bioavailability of the nutrients present in the pollen and retained in the bee bread.

In at least one embodiment, the plurality of honeycombs 1114 may be stored in the hive 1104 separate from the plurality of bee bread combs 1118. For example, the plurality of honeycombs 1114 may be positioned in a location within the hive 1104 and the plurality of bee bread combs 1118 may be positioned in another, different location within the hive 1104. In at least one other embodiment, the plurality of honeycombs 1114 may be placed in a same location as the plurality of bee bread combs 1118 within the hive 1104. In at least one embodiment, the plurality of honeycombs 1114 may be mixed with the plurality of bee bread combs 1118 within the hive 1104. Regardless of where the plurality of honeycombs 1114 and the plurality of bee bread combs 1118 may be situated relative to one another within the hive 1104, the plurality of honeycombs 1114 and the plurality of bee bread combs 1118 may be readily identified and separated from one another based at least on visual inspection.

Embodiments of the disclosure can be described in view of the following clauses:
1. A method, comprising:
   constraining pollen collection by a plurality to bees to a selection of plants;
   extracting a plant-derived material from one or more hives of the plurality of bees;
   measuring a content of one or more target compounds in the plant-derived material; and
   packaging the plant-derived material based, at least in part, on the content of the one or more target compounds.
2. The method of clause 1, wherein constraining the pollen collection includes enclosing the plurality of bees, the one or more hives, and the selection of plants within a structure, the structure comprising netting arranged over openings of the structure.
3. The method of clause 1 or clause 2, wherein the structure is a greenhouse, and wherein the netting is positioned at an intake cooling system, an exhaust system, and vents of the greenhouse.
4. The method of any of clauses 1-3, wherein the structure is hoop house, and wherein the netting is positioned along one or more sides of the hoop house.
5. The method of any of clauses 1-4, wherein constraining the pollen collection includes positioning the one or more hives at a central region of a geographic area, and wherein the geographic area is planted exclusively with the selection of plants.
6. The method of any of clauses 1-5, wherein the geographic area has a radius that is larger than a radius that the plurality of bees travel from the one or more hives.
7. The method of any of clauses 1-6, wherein the geographic area has a radius that is equal to or less than a radius that the plurality of bees travel from the one or more hives, and wherein the selection of plants are planted with a highest density proximate to the one or more hives.
8. A system for obtaining a bee product infused with one or more target compounds, comprising:
   one or more hives housing pollen-collecting bees;
   a plurality of selected plants surrounding the one or more hives; and
   a constraint imposed on the pollen-collecting bees to cause the pollen-collecting bees to obtain pollen from the plurality of selected plants, the pollen to be used to produce the bee product infused with the one or more target compounds.
9. The system of clause 8, wherein the constraint comprises one or more of a structure enclosing the plurality of selected plants or a geographic area cultivated with the plurality of selected plants.
10. The system of clause 8 or clause 9, wherein the plurality of selected plants comprises male C. sativa plants.
11. The system of one of clauses 8-10, wherein the constraint is one or both of a greenhouse or a hoop house that encloses the one or more hives and the plurality of selected plants as an exclusive source of pollen therein, and wherein openings of the greenhouse or the hoop house are covered with a netting comprising a mesh size that inhibits passage of the pollen-collecting bees through the netting.
12. The system of one of clauses 8-11, wherein the constraint is a field cultivated with the plurality of selected plants as an exclusive source of pollen in the field, and wherein the one or more hives are placed in a central region of the field.
13. The system of one of clauses 8-12, wherein the one or more hives include one or more pollen collection devices for collecting pollen obtained from the plurality of selected plants.
14. The system of one of clauses 8-13, wherein the bee product infused with the one or more target compounds comprises one or both of pollen infused with the one or more target compounds or bee bread infused with the one or more target compounds.
15. The system of one of clauses 8-14, wherein the bee product infused with the one or more target compounds comprises one or both of pollen infused with the one or more target compounds or bee bread infused with the one or more target compounds and mixed with honey.
16. A cannabinoid-infused bee product, comprising:
   a cannabinoid content derived from cannabis plant pollen, the cannabis plant pollen forming 75% or greater of a pollen count of the cannabinoid-infused bee product.
17. The cannabinoid-infused bee product of clause 16, wherein the cannabinoid-infused bee product is monofloral or multifloral.
18. The cannabinoid-infused bee product of clause 16 or clause 17, wherein the cannabinoid-infused bee product is a mixture of the cannabis plant pollen with honey, and wherein the cannabis plant pollen is collected from one or both of a pollen-collection device coupled to a hive or direct extraction from one or more cannabis plants.
19. The cannabinoid-infused bee product of any of clauses 16-18, wherein the cannabinoid-infused bee product is bee bread produced from the cannabis plant pollen, and wherein the bee bread is collected from a hive located in one or both of a structure enclosing cannabis plants from which the cannabis plant pollen is derived or a geographic area cultivated with the cannabis plants from which the cannabis plant pollen is derived.
20. The cannabinoid-infused bee product of any of clauses 16-19, wherein the cannabinoid-infused bee product is bee bread produced from the cannabis plant pollen, and wherein the bee bread is produced outside of a hive by fermenting the cannabis plant pollen in honey under controlled environmental conditions.

The specification and drawings are to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

What is claimed is:

1. A method, comprising:
constraining pollen collection by a plurality to bees to a selection of plants;
extracting a plant-derived material from one or more hives of the plurality of bees;
measuring a content of one or more target compounds in the plant-derived material; and
packaging the plant-derived material based, at least in part, on the content of the one or more target compounds.

2. The method of claim 1, wherein constraining the pollen collection includes enclosing the plurality of bees, the one or more hives, and the selection of plants within a structure, the structure comprising netting arranged over openings of the structure.

3. The method of claim 1, further comprising enclosing the plurality of bees, the one or more hives, and the selection of plants within a greenhouse having netting positioned at an intake cooling system, an exhaust system, and vents of the greenhouse.

4. The method of claim 1, further comprising enclosing the plurality of bees, the one or more hives, and the selection of plants within a hoop house having netting positioned along one or more sides of the hoop house.

5. The method of claim 1, wherein constraining the pollen collection includes positioning the one or more hives at a central region of a geographic area, and wherein the geographic area is planted exclusively with the selection of plants.

6. The method of claim 1, further comprising positioning the one or more hives in a geographic area having a radius that is larger than a radius that the plurality of bees travel from the one or more hives.

7. The method of claim 1, further comprising positioning the one or more hives in a geographic area having a radius that is equal to or less than a radius that the plurality of bees travel from the one or more hives, and wherein the selection of plants are planted with a highest density proximate to the one or more hives.

8. A system for obtaining a bee product infused with one or more target compounds, comprising:
one or more hives housing pollen-collecting bees;
a plurality of selected plants surrounding the one or more hives; and
a constraint imposed on the pollen-collecting bees to cause the pollen-collecting bees to obtain pollen from the plurality of selected plants, the pollen to be used to produce the bee product infused with the one or more target compounds.

9. The system of claim 8, wherein the constraint comprises one or more of a structure enclosing the plurality of selected plants or a geographic area cultivated with the plurality of selected plants.

10. The system of claim 8, wherein the plurality of selected plants comprises male C. sativa plants.

11. The system of claim 8, wherein the constraint is one or both of a greenhouse or a hoop house that encloses the one or more hives and the plurality of selected plants as an exclusive source of pollen therein, and wherein openings of the greenhouse or the hoop house are covered with a netting comprising a mesh size that inhibits passage of the pollen-collecting bees through the netting.

12. The system of claim 8, wherein the constraint is a field cultivated with the plurality of selected plants as an exclusive source of pollen in the field, and wherein the one or more hives are placed in a central region of the field.

13. The system of claim 8, wherein the one or more hives include one or more pollen collection devices for collecting pollen obtained from the plurality of selected plants.

14. The system of claim 8, wherein the bee product infused with the one or more target compounds comprises one or both of pollen infused with the one or more target compounds or bee bread infused with the one or more target compounds.

15. The system of claim 8, wherein the bee product infused with the one or more target compounds comprises one or both of pollen infused with the one or more target compounds or bee bread infused with the one or more target compounds and mixed with honey.

16. A cannabinoid-infused bee product, comprising:
a cannabinoid content derived from cannabis plant pollen, the cannabis plant pollen forming 75% or greater of a pollen count of the cannabinoid-infused bee product.

17. The cannabinoid-infused bee product of claim 16, wherein the cannabinoid-infused bee product is monofloral.

18. The cannabinoid-infused bee product of claim 16, wherein the cannabinoid-infused bee product comprises a mixture of the cannabis plant pollen with honey, and wherein the cannabis plant pollen is collected from one or both of a pollen-collection device coupled to a hive or direct extraction from one or more cannabis plants.

19. The cannabinoid-infused bee product of claim 16, wherein the cannabinoid-infused bee product comprises bee bread produced from the cannabis plant pollen, and wherein the bee bread is collected from a hive located in one or both of a structure enclosing cannabis plants from which the cannabis plant pollen is derived or a geographic area cultivated with the cannabis plants.

20. The cannabinoid-infused bee product of claim 16, wherein the cannabinoid-infused bee product comprises bee bread produced from the cannabis plant pollen, and wherein the bee bread is produced outside of a hive by fermenting the cannabis plant pollen in honey under controlled environmental conditions.
